(19) United States
(12) Patent Application Publication
(10) Pub. No.: US 2026/0180440 A1
(43) Pub. Date: Jun. 25, 2026

(54) CONTINUOUSLY SCALABLE CONVERSION RATIO (CSCR) VOLTAGE REGULATOR (VR) TOPOLOGIES

(71) Applicant: Nicolas Butzen, Portland, OR (US)

(72) Inventor: Nicolas Butzen, Portland, OR (US)

(21) Appl. No.: 18/999,256

(22) Filed: Dec. 23, 2024

(51) Int. Cl. H02M 3/07; H02M 3/00

(52) U.S. Cl. CPC H02M 3/07; H02M 3/003

(57) ABSTRACT

An apparatus includes a voltage regulator (VR). The VR includes a capacitor with a top plate and a bottom plate. The VR includes a first plurality of transistor switches (TSs) and a second plurality of TSs. The first plurality of TSs comprises a corresponding plurality of first switch terminals and a corresponding plurality of second switch terminals. The plurality of second switch terminals of the first plurality of TSs are coupled in parallel with each other and to the top plate. The second plurality of TSs includes a corresponding plurality of first switch terminals and a corresponding plurality of second switch terminals. The plurality of second switch terminals of the second plurality of TSs are coupled in parallel with each other and to the bottom plate.

### BACKGROUND

As the input voltage is increased in some conventional voltage regulator (VR) topologies beyond the voltage rating of the available devices, the capacitor and switch circuits in such VR topologies have to be implemented using stacked devices, thereby negatively impacting the overall system efficiency and power density.

### BRIEF DESCRIPTION OF THE DRAWINGS

In the drawings, like numerals may describe the same or similar components or features in different views. Like numerals having different letter suffixes may represent different instances of similar components. Some embodiments are illustrated by way of example, and not limitation, in the figures of the accompanying drawings listed below.

FIG. 1 is a phase diagram of a generalized CSCR VR phase schema, in accordance with some embodiments.

FIG. 2 is a block diagram of an example CSCR VR topology, in accordance with some embodiments.

FIG. 3 illustrates a diagram of cascading CSCR VR topologies, in accordance with some embodiments.

FIG. 4 illustrates a diagram of cascading parallel CSCR VR topologies, in accordance with some embodiments.

FIG. 5 is a graph of a comparison of the efficiency of a conventional CSCR topology with M/N=14/4 versus the cascaded/parallel configuration of the disclosed techniques, in accordance with some embodiments.

FIG. 6 and FIG. 7 illustrate graphs of a comparison of the safe operating region of CSCR topologies, in accordance with some embodiments.

FIG. 8 illustrates a CSCR VR topology, in accordance with some embodiments.

FIG. 9 illustrates a CSCR VR topology, in accordance with some embodiments.

FIG. 10 is a graph of a comparison of CSCR topologies, in accordance with some embodiments.

FIG. 11 is a graph of a comparison of CSCR topologies, in accordance with some embodiments.

FIG. 12 is a diagram illustrating CSCR VR phases for different CSCR VR configurations, in accordance with some embodiments.

FIG. 13 illustrates a CSCR VR topology, in accordance with some embodiments.

FIG. 14 illustrates a CSCR VR topology, in accordance with some embodiments.

FIG. 15 illustrates a CSCR VR topology, in accordance with some embodiments.

FIG. 16 is a graph of a comparison of various waveforms in a three-stage setup with CSCR VRs configured in different modes (e.g., an original boost mode and a safe boost mode), in accordance with some embodiments.

FIG. 17 is a flow diagram of an example method for manufacturing a VR, in accordance with some embodiments.

FIG. 18 illustrates a block diagram of an example machine upon which any one or more of the operations/techniques (e.g., methodologies) discussed herein may perform.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

The following description and the drawings sufficiently illustrate specific embodiments to enable those skilled in the art to practice them. Other embodiments may incorporate structural, logical, electrical, process, and other changes. Portions and features of some embodiments may be included in or substituted for those of other embodiments. Embodiments outlined in the claims encompass all available equivalents of those claims.

As used herein, the term “chip” (or die) refers to a piece of a material, such as a semiconductor material, that includes a circuit, such as an integrated circuit or a part of an integrated circuit. The term “memory IP” indicates memory intellectual property. The terms “memory IP,” “memory device,” “memory chip,” and “memory” are interchangeable.

The term “a processor” configured to carry out specific operations includes both a single processor configured to carry out all of the operations (e.g., operations or methods disclosed herein) as well as multiple processors individually configured to carry out some or all of the operations (which may overlap) such that the combination of processors carry out all of the operations.

As used herein, the term “IO” indicates input/output. As used herein, the term “R-C” indicates resistance and capacitance. As used herein, the term “Rx” indicates receiver (or receive). As used herein, the term “Tx” indicates transmitter (or transmit). As used herein, the term “TRX” indicates transceiver. As used herein, the term “UCIe” indicates Universal Chiplet Interconnect Express. As used herein, the term “Vref” indicates reference voltage. As used herein, the term “Vin” indicates input voltage. As used herein, the terms “serially coupled,” “serially connected,” and “connected in series” are synonymous to each other and indicate a serial connection between two or more components/circuits where the serial connection can be based on a direct or indirect electrical connection between the two or more components/circuits. As used herein, the terms “parallel coupled,” “parallel connected,” and “connected in parallel” are synonymous to each other and indicate a parallel connection between two or more components/circuits where the parallel connection can be based on a direct or indirect electrical connection between the two or more components/circuits.

In some aspects, a CSCR VR is configured to enable high-efficiency regulation of the output voltage without having to change the topology, as may be needed for fixed-ratio switched-capacitor (SC) converters. However, this topology has the downside that all of its capacitors have to be able to handle close to the entire input voltage and that a significant portion of its switches have to be rated for voltages up to the difference between the input voltage and output voltage. This means that as the input voltage is increased beyond the voltage rating of the available devices, these capacitors and switches have to be implemented using stacked devices, thereby negatively impacting the overall system efficiency and/or power density.

In some aspects, a CSCR-First topology can be configured, where fixed-ratio 2:1 stages are combined with a core CSCR stage, to push the input voltage higher. A drawback with this approach is that the safe operating range in terms of Vin/Vout is reduced relative to the original CSCR topology.

In some aspects, a CSCR topology can modulate the number of soft-charging phases and thus trade-off efficiency and current capability dynamically. While this approach can be effective at smaller voltage conversion ratios (large difference between Vin and Vout), when Vout is close to Vin, the current capability can be reduced because the CSCR topology does not have enough phases to establish its gyrator-like behavior.

In some aspects, the disclosed techniques can include CSCR topology configured in a “boost” mode to improve the current capability when Vout is close to Vin (even with Vout<Vin). However, this approach may lead to electrical overstress or cause body conduction (e.g., in some power FETs), particularly when the CSCR topology is combined with other converter stages. In some aspects, this mode uses an additional power FET compared with other CSCR topologies, leaving less area for the remaining power FETs.

The disclosed techniques include an alternative solution that relies on generalized CSCR-like stages and maintains a much wider operating range. A benefit of the disclosed techniques is that reconfigurability may not be needed for the disclosed topologies.

In contrast with the conventional topology, the disclosed CSCR VR topology has two outputs. The additional output nodes can be used as a fundamental building block to build new CSCR-derivative VR topologies through series/parallel/cascaded placement to increase the input voltage safely. Additionally, the CSCR-like behavior, in terms of efficient VCR modulation, is maintained, and the Vin/Vout range for which the converter can operate safely is maintained as well.

The disclosed techniques can be used to increase the safe operating region of a CSCR topology, allowing for new use cases and more flexible system architectures. In some aspects, the disclosed techniques can be used to increase the current capability of the CSCR topology, thus minimizing VR silicon area and manufacturing cost.

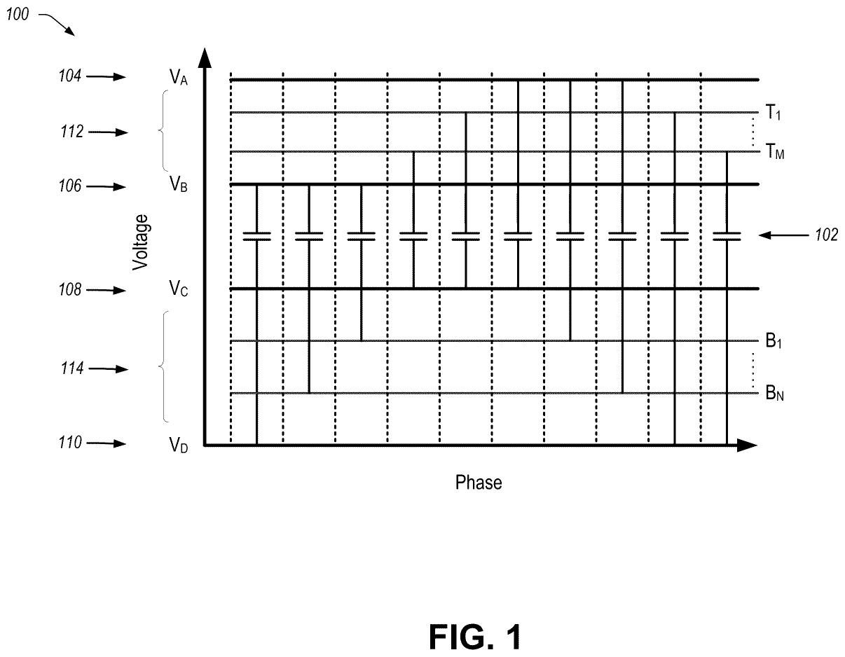

FIG. 1 is a phase diagram of a generalized CSCR VR phase schema, in accordance with some embodiments. Referring to FIG. 1, phase schema 100 is associated with a CSCR topology using a capacitor 102 and a plurality of switches (e.g., transistor switches or TSs, which are not illustrated in FIG. 1). More specifically, the top plate of capacitor 102 can be coupled (e.g., via a TS) to a first voltage signal 104 (or Va), a second voltage signal 106 (or Vb), or one or more intermediate voltage signals 112 (which can be between Va and Vb).

The bottom plate of capacitor 102 can be coupled to a third voltage signal 108 (or Vc), a fourth voltage signal 110 (or Vd), or one or more intermediate voltage signals 114 (which can be between Vc and Vd). Each of the voltage signals, Va, Vb, Vc, and Vd, can be associated with a separate voltage terminal. The intermediate voltage signals 112 are associated with intermediate voltage nodes T1-Tm, and intermediate voltage signals 114 are associated with intermediate voltage nodes B1-Bm.

In some aspects, Va is input voltage, Vd is Vss, and Vb and Vc are output voltages.

Compared with other CSCR topologies, the disclosed CSCR topology (including a CSCR topology based on FIG. 1) includes four (instead of three) converter terminals (e.g., four separate voltage terminals). As described above, the capacitor 102 top plate connects to Va and Vb (and the intermediate nodes T1-Tm), and the bottom plate connects to Vc and Vd (and B1-Bn). In contrast, in other topologies, they would connect to Vin and Vout and Vout and Vss, respectively. Thus, the disclosed topology can be configured by splitting the output voltage terminal Vout into two terminals, Vb and Vc. Likewise, the 3-terminal topology can be created from the disclosed 4-terminal topology by shorting Vb and Vc together.

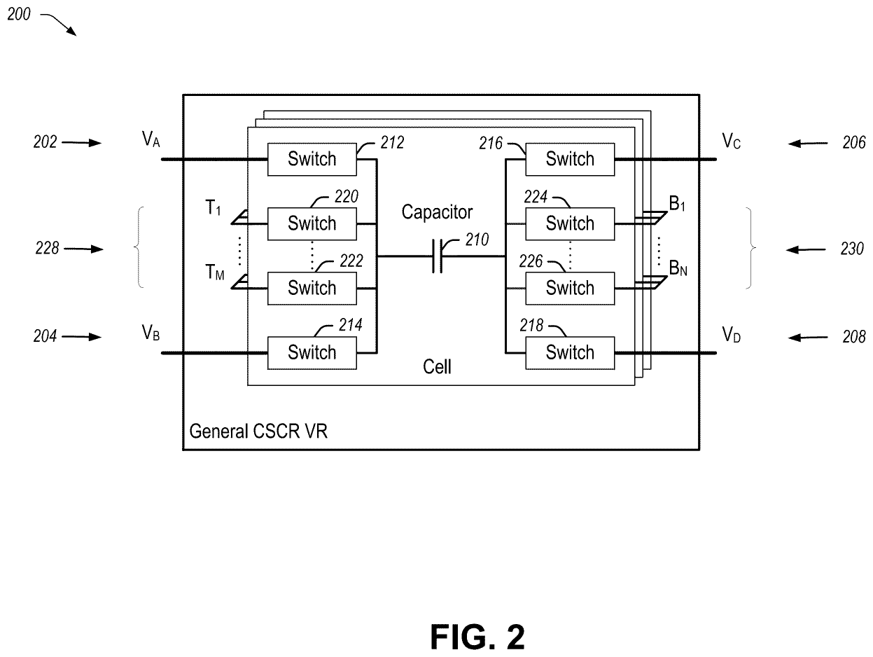

FIG. 2 is a block diagram of an example CSCR VR topology 200, in accordance with some embodiments. Referring to FIG. 2, the CSCR VR topology 200 includes a capacitor 210 and a plurality of transistor switches (TSs) 212-226. The top plate of capacitor 210 is coupled to a first voltage signal 202 (or Va) via TS 212 and to a second voltage signal 204 (or Vb) via TS 214. The top plate of capacitor 210 is also coupled to one or more intermediate voltage signals 228, which can be between Va and Vb and can be associated with intermediate voltage nodes (or terminals) T1-Tm.

The bottom plate of capacitor 210 is coupled to a third voltage signal 206 (or Vc) via TS 216 and to a fourth voltage signal 208 (or Vd) via TS 218. The bottom plate of capacitor 210 is also coupled to one or more intermediate voltage signals 230, which can be between Vc and Vd and can be associated with intermediate voltage nodes (or terminals) B1-Bm.

In some aspects, Va is input voltage, Vd is Vss, and Vb and Vc are output voltages.

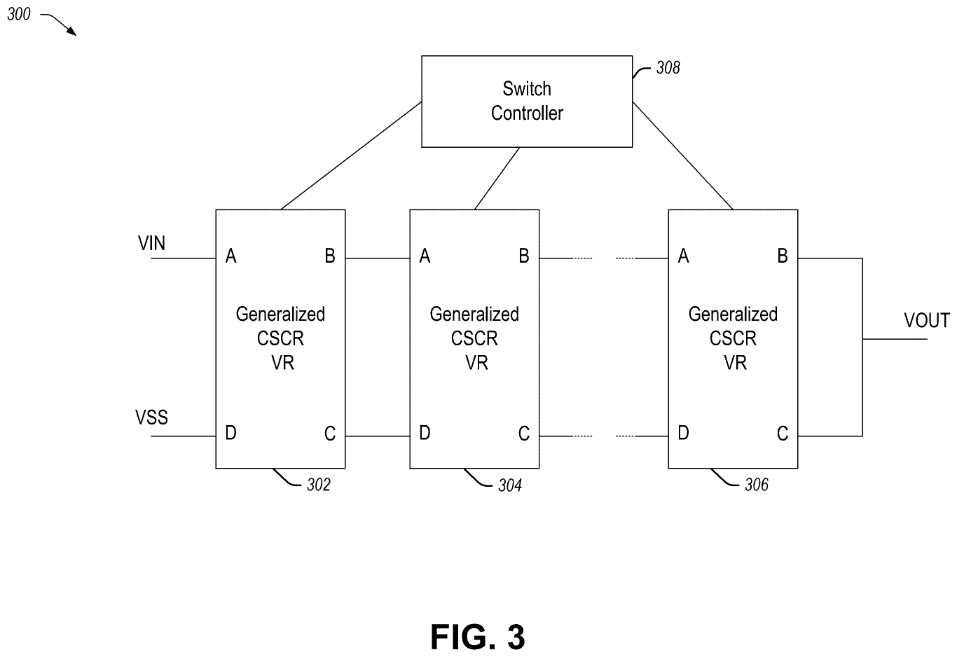

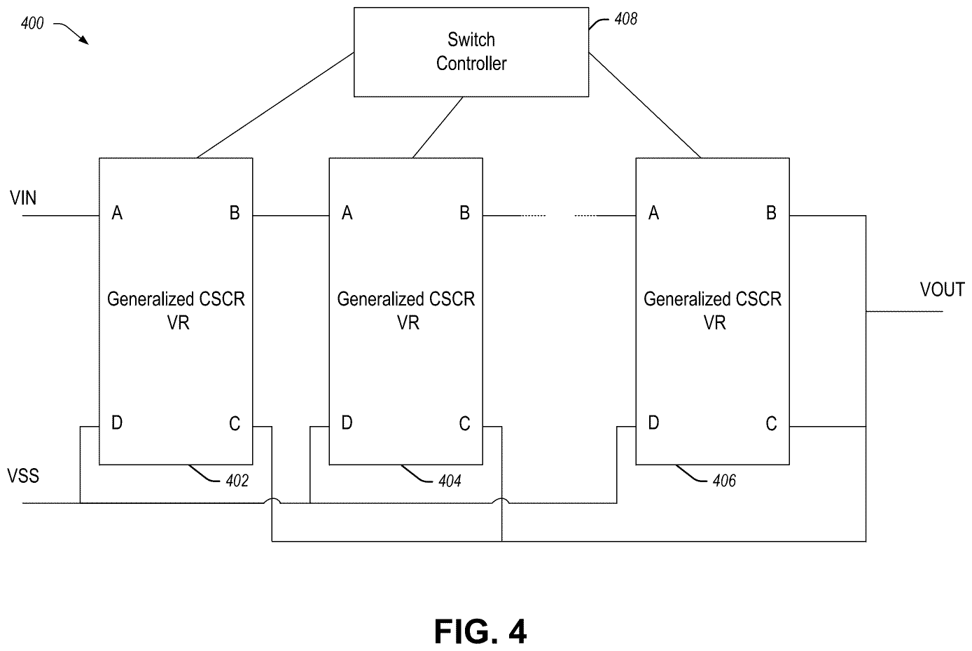

The main advantage of the disclosed CSCR topology is that it can serve as a building block to create new capacitive topologies (e.g., as illustrated in FIG. 3 and FIG. 4).

FIG. 3 illustrates a diagram 300 of cascading CSCR VR topologies, in accordance with some embodiments. Referring to FIG. 3, CSCR VRs 302, 304, . . . , 306 can be configured as the CSCR VR of FIG. 2 or other CSCR VR topologies disclosed herein. In some aspects, as illustrated in FIG. 3, the CSCR VRs can be cascaded with each other so that Va and Vb terminals of neighboring VRs, as well as Vd and Vc terminals, are connected in series with each other to generate a single output voltage Vout.

In some aspects, the cascading CSCR VR topology can include a switch controller 308, which can be used to configure and activate TSs for the top and bottom plates of the VR capacitor (e.g., capacitor 210).

In FIG. 3, several of the CSCR VRs are cascaded to generate a single output voltage Vout. Because every stage will partake in the voltage conversion effort, the maximum voltage that each stage sees will go down from left to right. This means that for high input voltages, the later stages can stack fewer capacitors/transistors to satisfy the device voltage ratings or will not have to stack at all, significantly improving the overall output current capability. Further, because the voltage step for each stage is lower, the number of intermediate rails (B1-Bn, T1-Tm) that are required per stage to obtain a specific overall efficiency is reduced as well. This means that each stage also has a lower switch count and requires a lower number of unique converter cells.

FIG. 4 illustrates diagram 400 of cascading parallel CSCR VR topologies, in accordance with some embodiments. Referring to FIG. 4, CSCR VRs 402, 404, . . . , 406 can be configured as the CSCR VR of FIG. 2 or other CSCR VR topologies disclosed herein. In some aspects, as illustrated in FIG. 3, the CSCR VRs can be cascaded with each other so that the Va and Vb terminals of neighboring VRs are connected in series with each other. In some aspects, the Vd terminals are connected in parallel with each other, and the Vc terminals are connected in parallel with each other.

In some aspects, the cascading CSCR VR topology can include a switch controller 408, which can be used to configure and activate TSs for the top and bottom plates of the VR capacitor of each of CSCR VRs 402, 404, . . . , 406.

Other configurations for mixing CSCR VR topologies (e.g., series/parallel/cascaded placement) can also yield potential benefits in terms of efficiency, output current, voltage rating, and so on.

In some aspects, the Vout may not exceed the thin-gate transistor voltage limit. If so, this could allow all of the bottom-electrode-connected power FETs of all the stages (connecting to Vc/Vd and B1-Bn) to be implemented without stacking devices. Similarly, if (Vin−Vout) does not exceed the same thin-gate transistor voltage limit, the same is true for the topside power FETs as well.

In some aspects, Vout can scale freely between Vin and Vss without causing any EOS concerns because the intermediate nodes between the various stages can adapt accordingly (e.g., automatically). In practice, there can be some limits due to the choice of stacking devices within every stage. In some aspects, the output voltage range can be limited to avoid having to stack transistors on the bottom side of each stage.

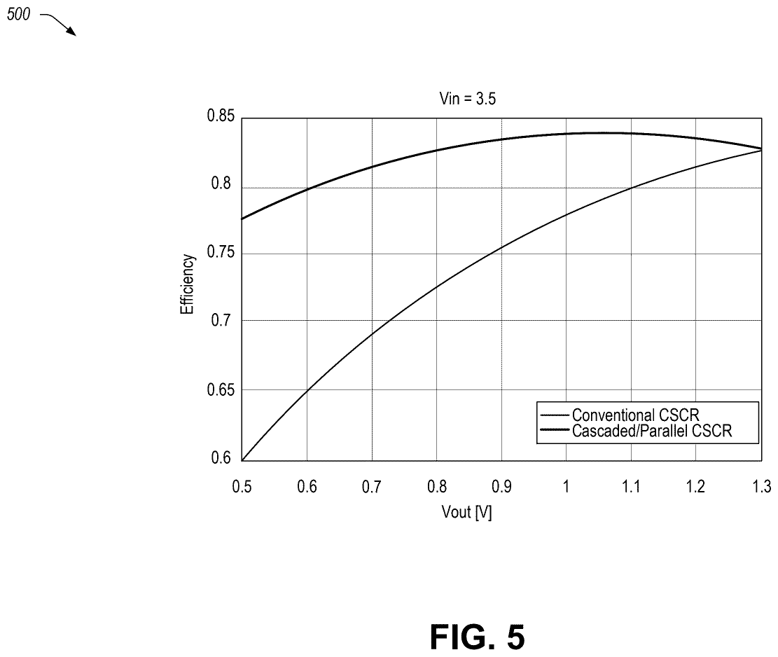

The potential performance benefit of this approach over a conventional CSCR topology is demonstrated in FIG. 5.

FIG. 5 is a graph 500 of a comparison of the efficiency of a conventional CSCR topology with M/N=14/4 versus the cascaded/parallel configuration of the disclosed techniques, in accordance with some embodiments.

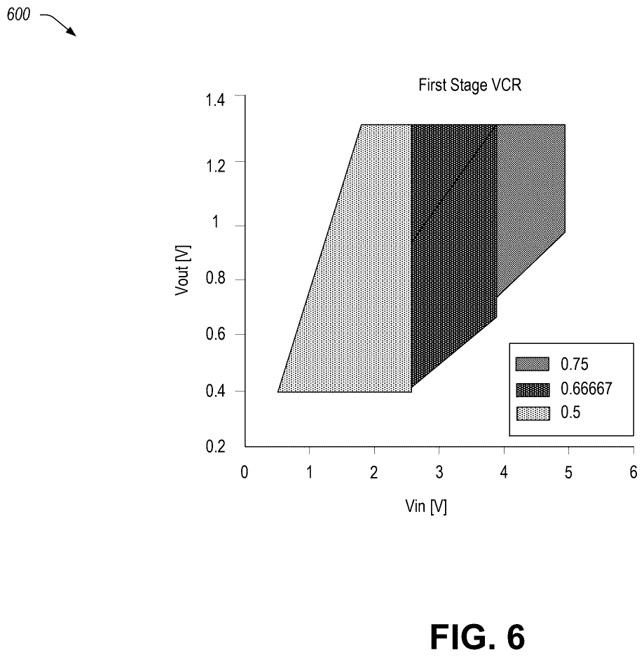

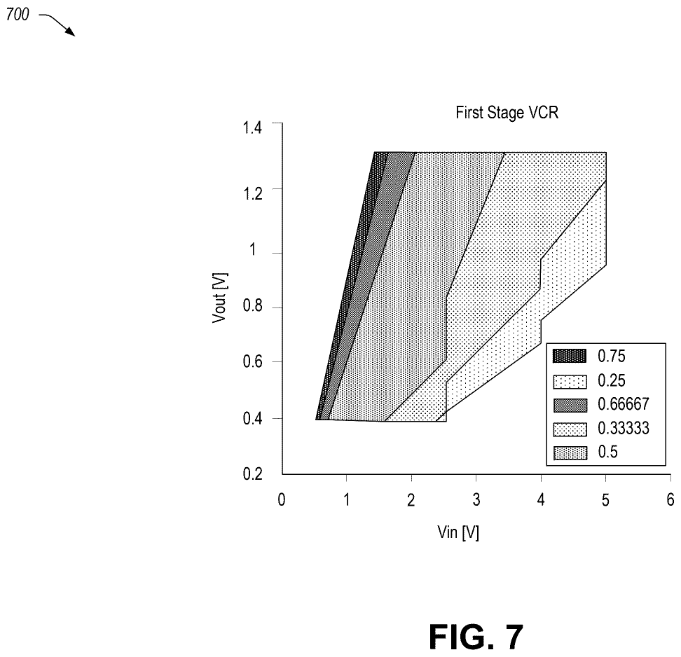

FIG. 6 and FIG. 7 illustrate corresponding graphs 600 and 700 comparing the safe operating region of CSCR topologies, in accordance with some embodiments.

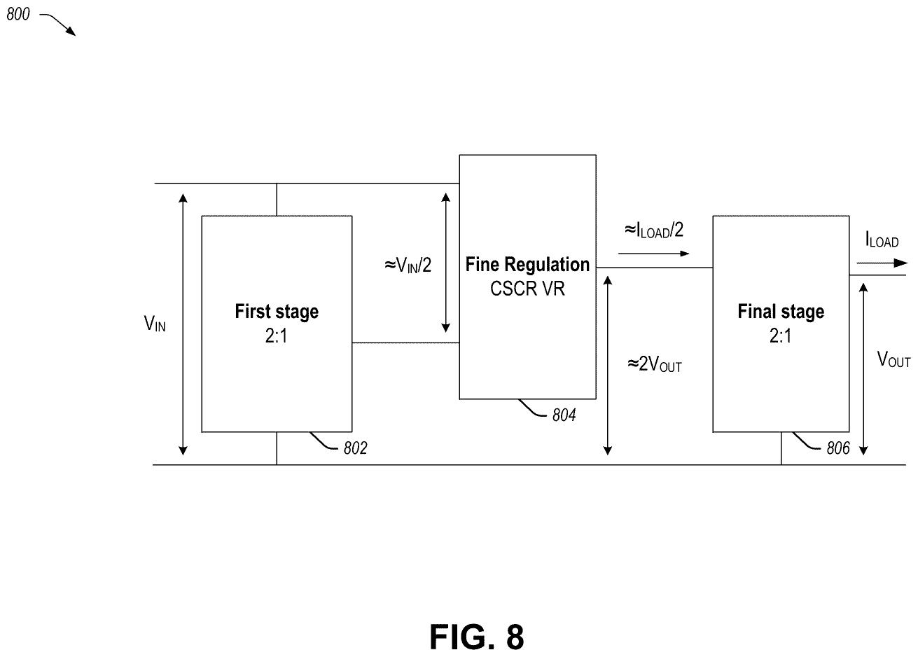

For example, FIG. 6 illustrates the safe operating region of the CSCR-First topology presented in FIG. 8. As illustrated in FIG. 6, while the topology does increase the input voltage of a CSCR topology beyond 1.3V, the fixed-ratio last stage that is introduced also limits the range of in- and output voltages for which the operation is safe. Safe, in this case, means none of the power transistors are experiencing Electrical Overstress (EOS) or body diode conduction in steady-state, nor does the flying capacitor voltage exceed a safe operating voltage.

FIG. 8 illustrates a CSCR-First VR topology, in accordance with some embodiments. Referring to FIG. 8, the CSCR-First topology 800 is configured as a quasi-three-stage solution, combining 2:1 fixed-ratio stages 802 and 806 and a CSCR stage 804 to enable input voltages up to twice the technology-rated voltage while retaining the CSCR-like behavior. However, this technique can cause a reduction in the safe input and output voltage range, limiting some of the flexibility of the CSCR topology. For example, sharing Vin between a wide range of different load domains, and so on.

The last stage fixed-ratio divider (stage 806) converts the CSCR stage output to the output of the entire topology. This also means that whatever output voltage range can be supported by the entire topology gets mapped to a more extensive range, as seen by the CSCR stage output. For example, the 2:1 last stage 806 means that a 1V range on the topology output maps to a 2V range at the CSCR stage output. This more extensive range makes it more likely that the CSCR output will either exceed its input voltage or be lower than its Vss node, leading to EOS and/or sustained body diode conduction in both cases.

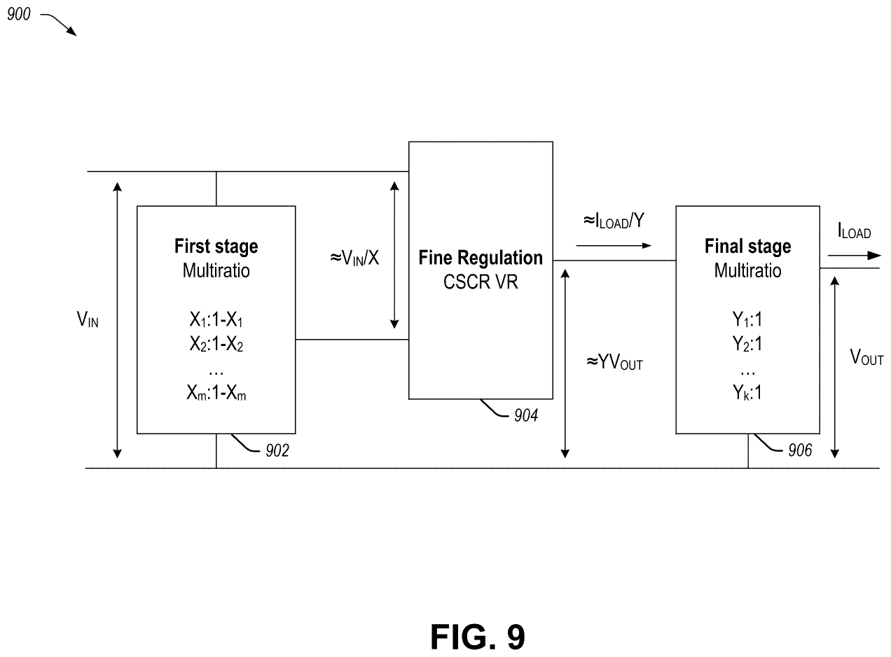

FIG. 9 illustrates a CSCR VR topology 900, in accordance with some embodiments. Referring to FIG. 9, CSCR topology 900 includes multi-ratio stages 902 and 906 coupled to a CSCR VR 904.

In some aspects, the first and last stages (e.g., stages 902 and 906) of the CSCR-first topology can be configured as multi-ratio stages that can switch between a range of conversion ratios (e.g., 2:1, 3:1, 3:2, and so on), while retaining the quasi-stage like behavior with benefits to soft-charging between stages and so on.

In this regard, the proposed techniques illustrated in FIG. 9 can be used to extend the safe input and/or output voltage range of the topology presented in FIG. 8 with coarse-grained control in the form of a multi-ratio last and/or first stage. By allowing the final stage 906 to switch between different ratios depending on the output and input voltage of the entire topology, the ratio can be chosen so that the input at the CSCR stage remains within its safe operating region. Additionally, allowing a multi-ratio first stage 902 can extend the safe input voltage range beyond what is possible with a fixed-ratio conversion. The effect of this can be appreciated in FIG. 9. Here, the disclosed techniques assume a multi-ratio (e.g., 2:1, 3:2, and 4:3) first stage 902 and a multi-ratio (e.g., 4:1, 3:1,2:1, 3:2, 4:3) last stage 906. This extended range can simplify power delivery architectures, allowing a wider range of power domains to be powered by converters that are tied to the same input voltage. This also can improve performance and platform cost (e.g., reduction in platform rails, VRMs, and so on). Moreover, the input voltage range variation can enable new use cases (e.g., direct-battery attach (DBA) power conversion).

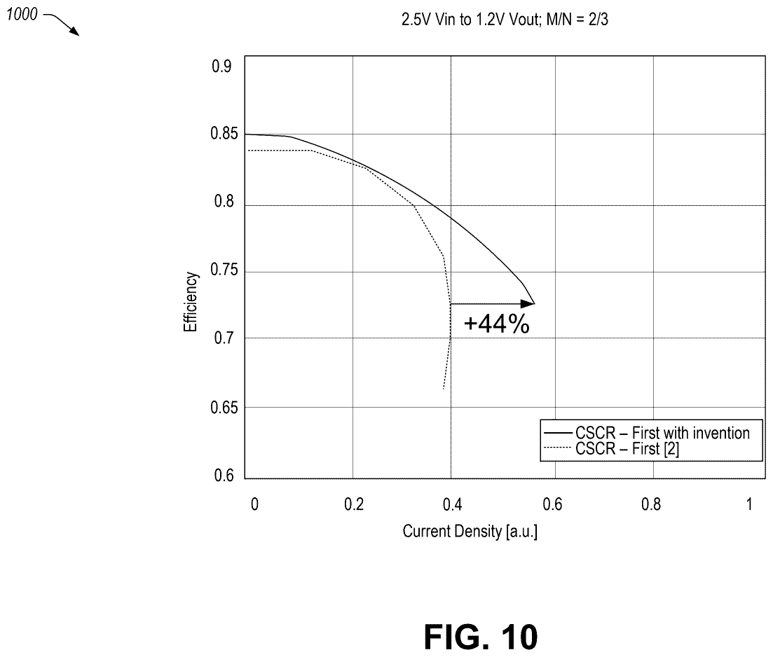

FIG. 10 is graph 1000 of a comparison of CSCR topologies, in accordance with some embodiments.

As can be deduced from FIG. 10, a key advantage of the disclosed techniques illustrated in FIG. 9 is that it increases the safe operating region of the entire CSCR-First topology (e.g., the topology of FIG. 8), allowing for new use cases and more flexible system architectures. Additionally, in some scenarios, the disclosed techniques can increase the current capability of the CSCR-First topology, thus minimizing the required VR silicon area and, thus, cost. As can be seen in FIG. 10, even though a 2.5V to 1.2V conversion can be safely handled by the original CSCR-First topology, the current capability is limited because the output of the CSCR stage is close to its input voltage. By switching to a 3:2 last-stage conversion ratio instead, the efficiency and, importantly, the current capability see a significant boost.

In some aspects, a CSCR topology can rely on adding a high number of soft-charging phases, leading to a large total number of converter phases, as well as a number of time-interleaved converter cells. At the same time, given a fixed control frequency, its output current is inversely proportionate to the number of phases.

In some aspects, a CSCR topology can be based on modulating the number of soft-charging phases and thus trade-off efficiency and current capability dynamically. While this approach is practical at smaller voltage conversion ratios (significant difference between Vin and Vout), when Vout is close to Vin, the current capability can actually reduce because the CSCR topology does not have enough phases to establish its gyrator-like behavior.

In some aspects, a CSCR topology can be configured to operate in a “boost” mode to improve the current capability when Vout is close to Vin (even with Vout<Vin). However, this approach can lead to electrical overstress or body conduction in some power, particularly when the CSCR topology is combined with other converter stages. Additionally, this mode can use an additional power FET compared with the regular CSCR topology, leaving less area for the remaining power FETs.

In some aspects, the disclosed techniques include a CSCR mode referred to as “safe boost,” which improves the current capability by up to two times when Vout is close to Vin without causing EOS issues and while re-using the power FETs that are already present in CSCR topologies.

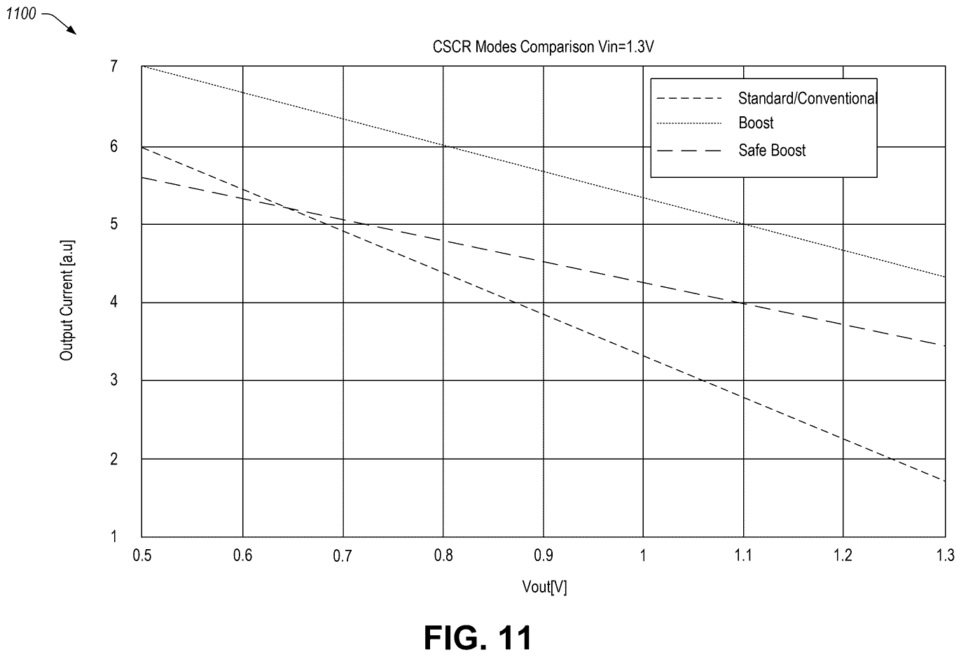

FIG. 11 is a graph 1100 of a comparison of CSCR topologies, in accordance with some embodiments.

The CSCR switched capacitor (SC) DC-DC converter topology has many advantages, in particular when it comes to maintaining efficiency over a wide range of load current and input/output voltage conditions. In this topology, there is a trade-off between efficiency and output current capability. The higher the number of soft-charging phases, where the flying capacitors'top/bottom electrode connects to intermediate nodes T1-Tm, B1-Bn, the slower the gradual charging/discharging of the capacitor, and the higher the efficiency, but at the cost of lower output current.

In some aspects, the disclosed techniques include modulation of the effective number of T1-Tm and B1-Bn (M and N respectively) at runtime. However, when the CSCR's output voltage is close to its input voltage and M and N drop below two, the current capability will degrade. This is because M/N is not sufficiently high to establish the desired gyrator behavior in the topology, as can also be seen in FIG. 11.

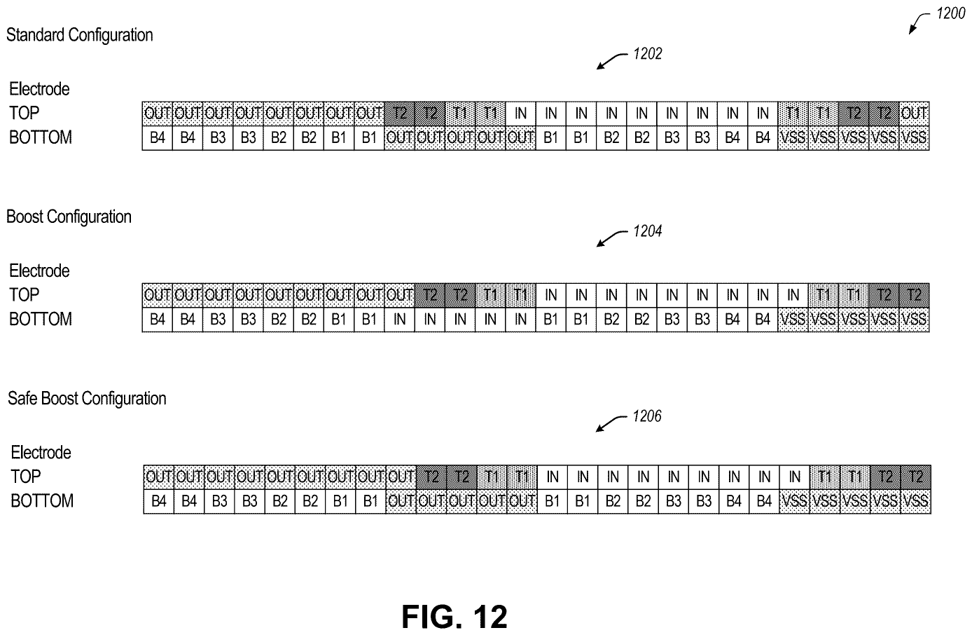

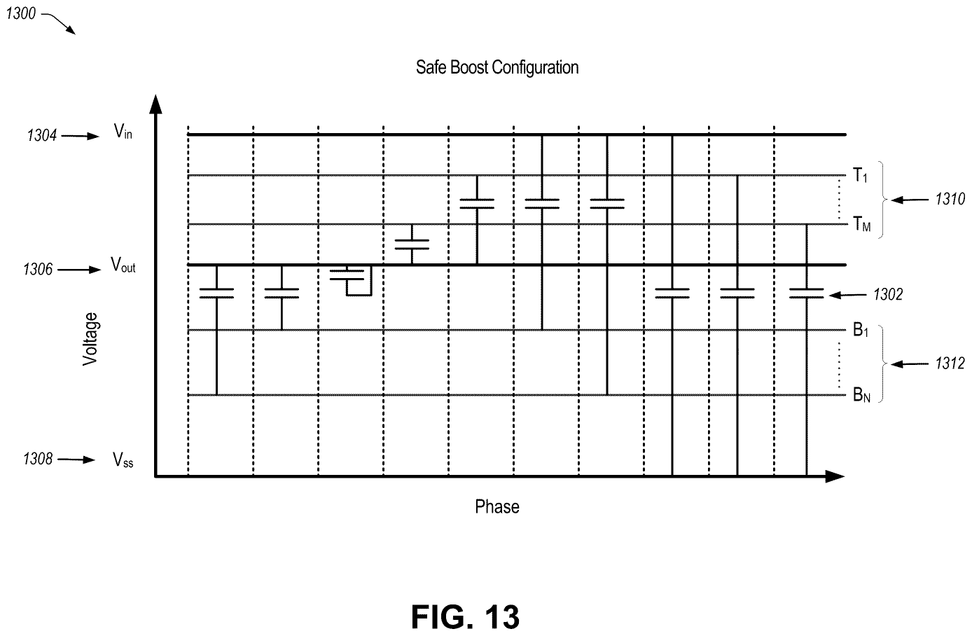

FIG. 12 is a diagram 1200 illustrating CSCR VR phases for different CSCR VR configurations 1202, 1204, and 1206, in accordance with some embodiments. Referring to FIG. 12, configuration 1202 (also referred to as a “standard configuration”), configuration 1204 (also referred to as “boost configuration”), and configuration 1206 (also referred to as “safe boost configuration”) indicates how the capacitor (e.g., any of the capacitors illustrated in the figures) top plate and bottom plate are connected to various voltage sources (e.g., voltage nodes between Vin and Vss as illustrated in FIG. 13).

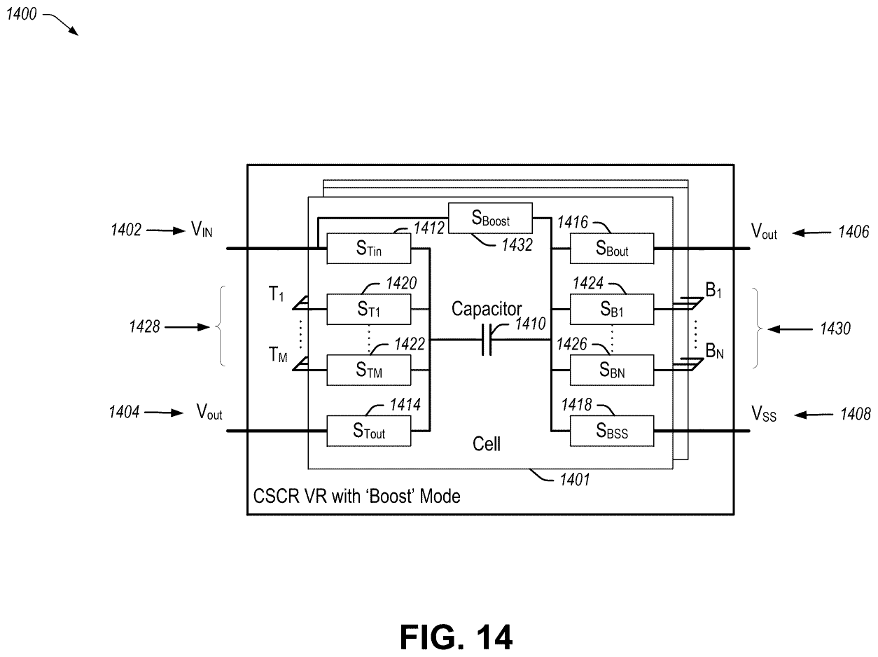

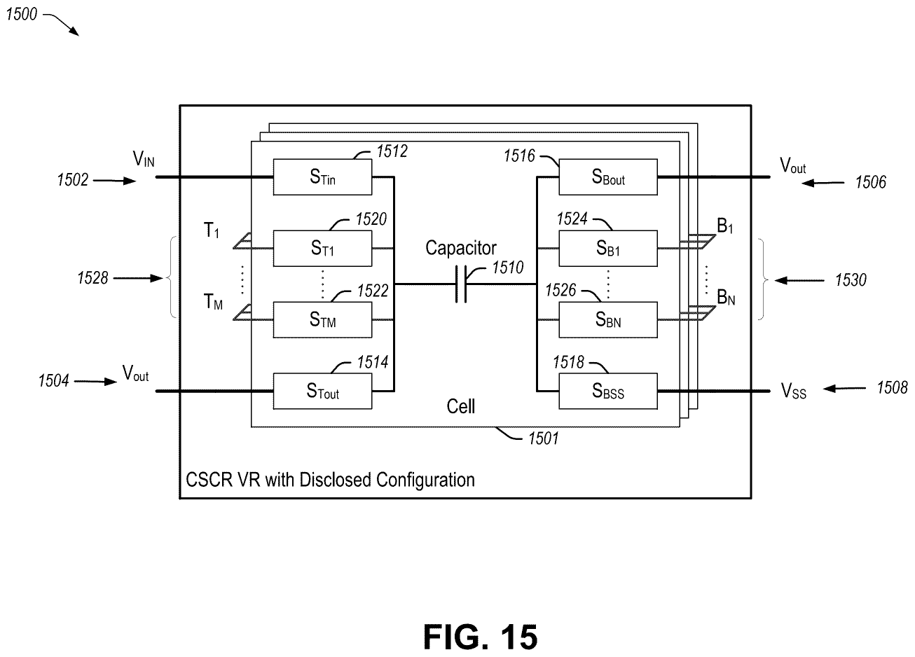

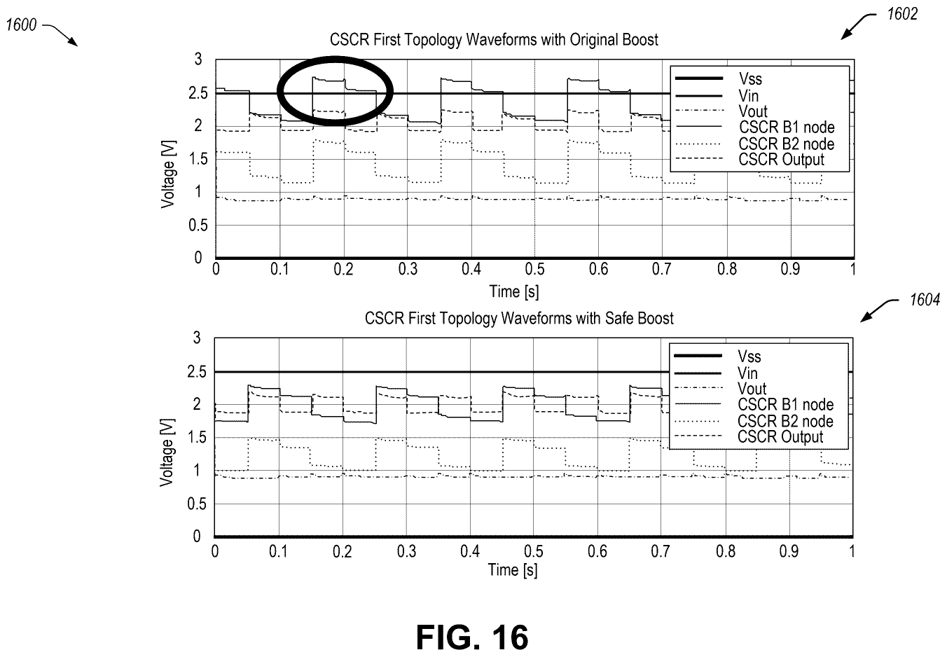

In some aspects, a “safe boost” mode is characterized by the phases being primarily based on the conventional operation of the CSCR topology. The phases where the capacitor would typically connect to Vout/Vss and Vin/Vout are removed. Instead, other phases are introduced (between different soft-charging phases as well) where the capacitor connects to Vout/Vout and Vin/Vss. As demonstrated in FIG. 11, the “safe boost” mode provides up to two times higher output current when Vout is close to Vin and M/N is low. As demonstrated in FIG. 16, there are no EOS concerns like those shown by the “boost” mode. Because the bottom electrode of the capacitor no longer must connect to Vin, there is no additional power FET required on top of what is already there in the CSCR operation, as portrayed in FIG. 14 and FIG. 15.

In this regard, the proposed “safe boost” configuration enables higher output current capability of CSCR-based SC converters in practical applications, lowering silicon footprint and, thus, cost iso-output current.

FIG. 13 illustrates a CSCR VR topology 1300, in accordance with some embodiments. Referring to FIG. 13, topology 1300 is based on the “safe boost” configuration 1206 of FIG. 12. More specifically, capacitor 1302 includes a top plate that can be coupled to Vin 1304, Vout 1306, or any of the intermediate voltage nodes 1310. Similarly, capacitor 1302 includes a bottom plate that can be coupled to Vout 1306, Vss 1308, or any of the intermediate voltage nodes 1312.

FIG. 14 illustrates a CSCR VR topology 1400, in accordance with some embodiments. Referring to FIG. 14, the CSCR VR topology 1400 includes a CSCR cell 1401 capacitor 1410 and a plurality of transistor switches (TSs) 1412-1426. The top plate of capacitor 1410 is coupled to a first voltage signal 1402 (or Vin) via TS 1412 and to a second voltage signal 1404 (or Vout) via TS 1414. The top plate of capacitor 1410 is also coupled to one or more intermediate voltage signals 1428, which can be between Vin and Vout and can be associated with intermediate voltage nodes (or terminals) T1-Tm.

The bottom plate of capacitor 1410 is coupled to a third voltage signal 1406 (or Vout, which can be the same as the second voltage signal 1404) via TS 1416 and to a fourth voltage signal 1408 (or Vss) via TS 1418. The bottom plate of capacitor 210 can also be coupled to one or more intermediate voltage signals 1430, which can be between Vout and Vss and can be associated with intermediate voltage nodes (or terminals) B1-Bm.

As per FIG. 11, the current capability of the “boost” mode does not lag nearly as much as Vout gets closer to Vin. However, to enable this mode, the negative or bottom electrode of the flying capacitors must connect to Vin, as illustrated in FIG. 12. In practice, this means an additional transistor (e.g., TS 1432) is required, as illustrated in FIG. 14. This transistor can be large, as it carries a large amount of current for many phases and thus eats into the total transistor budget. Alternatively, it increases the cost by increasing the transistor budget.

FIG. 15 illustrates a CSCR VR topology 1500, in accordance with some embodiments. Referring to FIG. 15, the CSCR VR topology 1500 includes a CSCR cell 1501 with a capacitor 1510 and a plurality of transistor switches (TSs) 1512-1526. The top plate of capacitor 1510 is coupled to a first voltage signal 1502 (or Vin) via TS 1512 and to a second voltage signal 1504 (or Vout) via TS 1514. The top plate of capacitor 1510 is also coupled to one or more intermediate voltage signals 1528, which can be between Vin and Vout and can be associated with intermediate voltage nodes (or terminals) T1-Tm.

The bottom plate of capacitor 1510 is coupled to a third voltage signal 1506 (or Vout, which can be the same as the second voltage signal 1504) via TS 1516 and to a fourth voltage signal 1508 (or Vss) via TS 1518. The bottom plate of capacitor 1510 can also be coupled to one or more intermediate voltage signals 1530, which can be between Vout and Vss and can be associated with intermediate voltage nodes (or terminals) B1-Bm.

FIG. 16 is graph 1600 of a comparison of various waveforms in a three-stage setup with CSCR VRs configured in different modes (e.g., graph 1602 associated with the “boost” mode and graph 1604 associated with the “safe boost” mode), in accordance with some embodiments.

When the CSCR topology is combined with other stages, for example, to increase the input voltage, the “boost” mode can boost some of the internal nodes of the CSCR stage beyond the input voltage, shown in FIG. 16, causing some of the devices to experience too high a voltage (Electrical Over-Stress or EOS) or body diode conduction. Naturally, this can degrade the reliability of the complete voltage regulator solution and would limit its useability for any product.

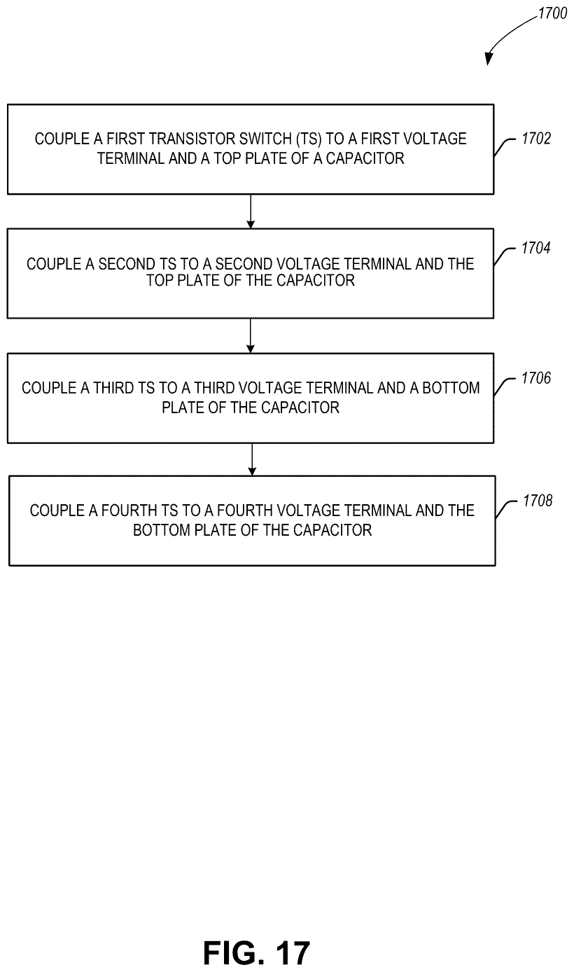

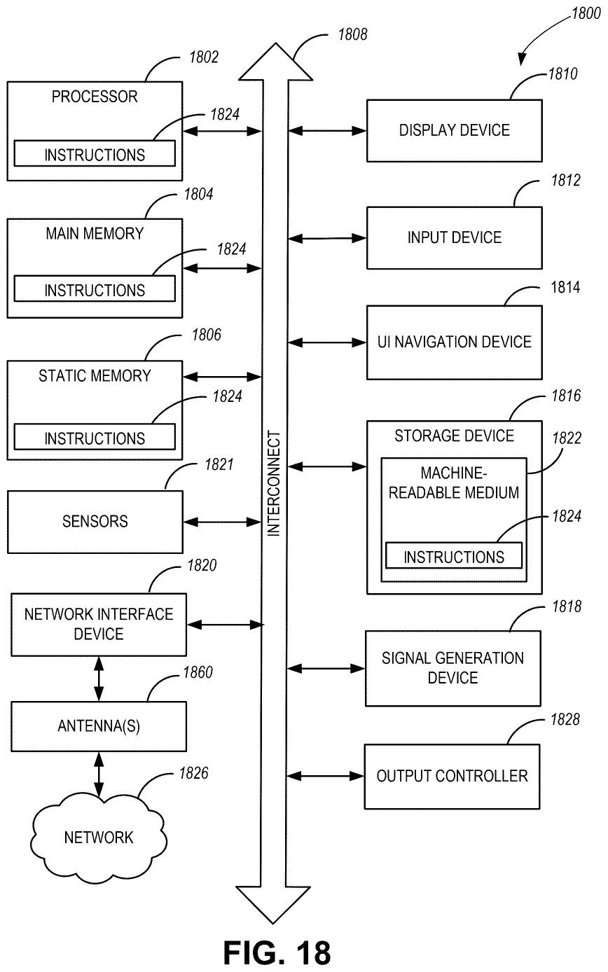

FIG. 17 is a flow diagram of an example method for manufacturing a VR, in accordance with some embodiments. Referring to FIG. 17, method 1700 includes operations 1702, 1704, 1706, and 1708, which may be executed by a processor, an embedded controller, a receiver circuit, a transceiver circuit, or another processor of a computing device (e.g., hardware processor 1802 of machine 1800 illustrated in FIG. 18, which can include one or more of the circuits discussed in connection with FIGS. 1-16). In some embodiments, one or more of the circuits discussed in connection with FIGS. 1-16 can perform the functionalities (or include the configurations or circuitry) associated with FIG. 17, as well as one or more of the examples listed below.

At operation 1702, a first transistor switch (TS) is coupled to a first voltage terminal and a top plate of a capacitor.

At operation 1704, a second TS is coupled to a second voltage terminal and the top plate of the capacitor.

At operation 1706, a third TS is coupled to a third voltage terminal and a bottom plate of the capacitor.

At operation 1708, a fourth TS is coupled to a fourth voltage terminal and the bottom plate of the capacitor.

FIG. 18 illustrates a block diagram of an example machine 1800 upon which any one or more of the techniques (e.g., methodologies) discussed herein may perform. In alternative embodiments, the machine 1800 may operate as a standalone device or may be connected (e.g., networked) to other machines. In a networked deployment, machine 1800 may operate in the capacity of a server machine, a client machine, or both in server-client network environments. In an example, machine 1800 may function as a peer machine in a peer-to-peer (P2P) (or other distributed) network environment. Machine 1800 may be a personal computer (PC), a tablet PC, a set-top box (STB), a personal digital assistant (PDA), a portable communications device, a mobile telephone, a smartphone, a web appliance, a network router, switch or bridge, or any other computing device capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. The terms “machine,” “computing device,” and “computer system” are used interchangeably.

Machine (e.g., computer system) 1800 may include a hardware processor 1802 (e.g., a central processing unit (CPU), a graphics processing unit (GPU), a hardware processor core, or any combination thereof), a main memory 1804, and a static memory 1806, some or all of which may communicate with each other via an interlink (e.g., bus) 1808. In some aspects, the main memory 1804, the static memory 1806, or any other type of memory (including cache memory) used by machine 1800 can be configured based on the disclosed techniques or can implement the disclosed memory devices.

Specific examples of main memory 1804 include Random Access Memory (RAM) and semiconductor memory devices, which may include, in some embodiments, storage locations in semiconductors such as registers. Specific examples of static memory 1806 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

Machine 1800 may further include a display device 1810, an input device 1812 (e.g., a keyboard), and a user interface (UI) navigation device 1814 (e.g., a mouse). In an example, the display device 1810, the input device 1812, and the UI navigation device 1814 may be a touchscreen display. The machine 1800 may additionally include a storage device (e.g., drive unit or another mass storage device) 1816, a signal generation device 1818 (e.g., a speaker), a network interface device 1820, and one or more sensors 1821, such as a global positioning system (GPS) sensor, compass, accelerometer, or other sensors. The machine 1800 may include an output controller 1828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments, the hardware processor 1802 and/or instructions 1824 may comprise processing circuitry and/or transceiver circuitry.

The storage device 1816 may include a machine-readable medium 1822 on which one or more sets of data structures or instructions 1824 (e.g., software) embodying or utilized by any one or more of the techniques or functions described herein can be stored. Instructions 1824 may also reside, completely or at least partially, within the main memory 1804, within static memory 1806, or the hardware processor 1802 during execution thereof by machine 1800. In an example, one or any combination of the hardware processor 1802, the main memory 1804, the static memory 1806, or the storage device 1816 may constitute machine-readable media.

Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine-readable medium 1822 is illustrated as a single medium, the term “machine-readable medium” may include a single medium or multiple media (e.g., a centralized or distributed database and/or associated caches and servers) configured to store instructions 1824.

An apparatus of machine 1800 may be one or more of a hardware processor 1802 (e.g., a central processing unit (CPU), a graphics processing unit (GPU), a hardware processor core, or any combination thereof), a main memory 1804 and a static memory 1806, one or more sensors 1821, a network interface device 1820, one or more antennas 1860, a display device 1810, an input device 1812, a UI navigation device 1814, a storage device 1816, instructions 1824, a signal generation device 1818, and an output controller 1828. The apparatus may be configured to perform one or more of the methods and/or operations disclosed herein. The apparatus may be intended as a component of machine 1800 to perform one or more of the methods and/or operations disclosed herein and/or to perform a portion of one or more of the methods and/or operations disclosed herein. In some embodiments, the apparatus may include a pin or other means to receive power. In some embodiments, the apparatus may include power conditioning hardware.

The term “machine-readable medium” may include any medium that is capable of storing, encoding, or carrying instructions for execution by machine 1800 and that causes machine 1800 to perform any one or more of the techniques of the present disclosure or that is capable of storing, encoding, or carrying data structures used by or associated with such instructions. Non-limiting machine-readable medium examples may include solid-state memories and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine-readable media may include non-transitory machine-readable media. In some examples, machine-readable media may include machine-readable media that is not a transitory propagating signal.

The instructions 1824 may further be transmitted or received over a communications network 1826 using a transmission medium via the network interface device 1820 utilizing any one of several transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.8.4 family of standards, a Long Term Evolution (LTE) family of standards, a Universal Mobile Telecommunications System (UMTS) family of standards, peer-to-peer (P2P) networks, among others.

In an example, the network interface device 1820 may include one or more physical jacks (e.g., Ethernet, coaxial, or phone jacks) or one or more antennas to connect to the communications network 1826. In an example, the network interface device 1820 may include one or more antennas 1860 to wirelessly communicate using at least one single-input multiple-output (SIMO), multiple-input multiple-output (MIMO), or multiple-input single-output (MISO) techniques. In some examples, the network interface device 1820 may wirelessly communicate using multiple-user MIMO techniques. The term “transmission medium” shall be taken to include any intangible medium that can store, encode, or carry instructions for execution by machine 1800 and includes digital or analog communications signals or other intangible media to facilitate communication of such software.

Examples, as described herein, may include, or may operate on, logic or several components, modules, or mechanisms. Modules are tangible entities (e.g., hardware) capable of performing specified operations and may be configured or arranged in a particular manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part, all, or any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at separate times. The software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM), random access memory (RAM), magnetic disk storage media, optical storage media, flash memory, etc.

The above-detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, examples that include the elements shown or described are also contemplated. Moreover, also contemplated are examples using any combination or permutation of those elements shown or described (or one or more aspects thereof), either with respect to a particular example (or one or more aspects thereof) or with respect to other examples (or one or more aspects thereof) shown or described herein.

Publications, patents, and patent documents referred to in this document are incorporated by reference herein in their entirety, as though individually incorporated by reference. In the event of inconsistent usage between this document and those documents so incorporated by reference, the usage in the incorporated reference(s) is supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc., are used merely as labels and are not intended to suggest a numerical order for their objects.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in several environments, such as part of a system on chip, a set of intercommunicating functional blocks, or similar, although the scope of the disclosure is not limited in this respect.

Described implementations of the subject matter can include one or more features, alone or in combination, as illustrated below by way of examples.
Example 1 is an apparatus (e.g., a voltage regulator (VR) circuit) comprising a first transistor switch (TS) comprising a first switch terminal coupled to a first voltage terminal and a second switch terminal coupled to a top plate of a capacitor, the first voltage terminal to provide a first voltage signal; a second TS comprising a first switch terminal coupled to a second voltage terminal and a second switch terminal coupled to the top plate and coupled in parallel with the second switch terminal of the first TS, the second voltage terminal to provide a second voltage signal; a third TS comprising a first switch terminal coupled to a third voltage terminal and a second switch terminal coupled to a bottom plate of the capacitor, the third voltage terminal to provide a third voltage signal; and a fourth TS comprising a first switch terminal coupled to a fourth voltage terminal and a second switch terminal coupled to the bottom plate and coupled in parallel with the second switch terminal of the third TS, the fourth voltage terminal to provide a fourth voltage signal.
In Example 2, the subject matter of Example 1 includes a first set of intermediate TSs, each intermediate TS of the first set of intermediate TSs comprising a first switch terminal and a second switch terminal, the first set of intermediate TSs coupled in parallel with each other, with the first TS, and with the second TS via the second switch terminal of each of the first set of intermediate TSs.
In Example 3, the subject matter of Example 2 includes a first set of intermediate voltage terminals, each intermediate voltage terminal of the first set of intermediate voltage terminals coupled to the first switch terminal of a corresponding intermediate TS of the first set of intermediate TSs.
In Example 4, the subject matter of Example 3 includes a second set of intermediate TSs, each intermediate TS of the second set of intermediate TSs comprising a first switch terminal and a second switch terminal, the second set of intermediate TSs coupled in parallel with each other, with the third TS, and with the fourth TS via the second switch terminal of each of the second set of intermediate TSs.
In Example 5, the subject matter of Example 4 includes a second set of intermediate voltage terminals, each intermediate voltage terminal of the second set of intermediate voltage terminals coupled to the first switch terminal of a corresponding intermediate TS of the second set of intermediate TSs.
In Example 6, the subject matter of Examples 1-5 includes a fifth TS comprising a first switch terminal and a second switch terminal, the first switch terminal coupled to the first switch terminal of the first TS, and the second switch terminal coupled to the second switch terminal of the third TS.
In Example 7, the subject matter of Examples 1-6 includes subject matter where the third voltage terminal is coupled in series with a first voltage terminal of at least another VR circuit and wherein the fourth voltage terminal is coupled in series with a second voltage terminal of the at least another VR circuit.
In Example 8, the subject matter of Examples 1-7 includes subject matter where the third voltage terminal is coupled in series with a first voltage terminal of at least another VR circuit and wherein the fourth voltage terminal is coupled in parallel with a fourth voltage terminal of the at least another VR circuit.
In Example 9, the subject matter of Examples 4-8 includes subject matter where the apparatus comprises a system-on-chip (SoC), the SoC comprising an integrated circuit (IC), the IC comprising at least two of the first TS, the second TS, the third TS, the fourth TS, the first set of intermediate TSs, and the second set of intermediate TSs.
In Example 10, the subject matter of Example 9 includes subject matter where the SoC further comprises at least one connector and wherein the at least one connector conforms with at least one of Universal Serial Bus (USB), High-Definition Multimedia Interface (HDMI), Thunderbolt, Peripheral Component Interconnect Express (PCIe), and Ethernet specifications.
Example 11 is an apparatus comprising a first voltage regulator (VR) comprising a capacitor comprising a top plate and a bottom plate; a first plurality of transistor switches (TSs), the first plurality of TSs comprising a corresponding plurality of first switch terminals, and a corresponding plurality of second switch terminals, the plurality of second switch terminals of the first plurality of TSs coupled in parallel with each other and to the top plate; and a second plurality of TSs, the second plurality of TSs comprising a corresponding plurality of first switch terminals and a corresponding plurality of second switch terminals, the plurality of second switch terminals of the second plurality of TSs coupled in parallel with each other and to the bottom plate.
In Example 12, the subject matter of Example 11 includes subject matter where the first plurality of TSs comprises a first TS comprising a first switch terminal coupled to a first voltage terminal and a second switch terminal coupled to the top plate, the first voltage terminal to provide a first voltage signal; and a second TS comprising a first switch terminal coupled to a second voltage terminal and a second switch terminal coupled to the top plate, the second voltage terminal to provide a second voltage signal.
In Example 13, the subject matter of Example 12 includes subject matter where the second plurality of TSs comprises a third TS comprising a first switch terminal coupled to a third voltage terminal and a second switch terminal coupled to the bottom plate, the third voltage terminal to provide a third voltage signal; and a fourth TS comprising a first switch terminal coupled to a fourth voltage terminal and a second switch terminal coupled to the bottom plate, the fourth voltage terminal to provide a fourth voltage signal.
In Example 14, the subject matter of Example 13 includes subject matter where the first plurality of TSs comprises a first set of intermediate TSs, each intermediate TS of the first set of intermediate TSs comprising a first switch terminal and a second switch terminal, the first set of intermediate TSs coupled in parallel with each other, with the first TS, and with the second TS via the second switch terminal of each of the first set of intermediate TSs; and a first set of intermediate voltage terminals, each intermediate voltage terminal of the first set of intermediate voltage terminals coupled to the first switch terminal of a corresponding intermediate TS of the first set of intermediate TSs.
In Example 15, the subject matter of Example 14 includes subject matter where the second plurality of TSs comprises a second set of intermediate TSs, each intermediate TS of the second set of intermediate TSs comprising a first switch terminal and a second switch terminal, the second set of intermediate TSs coupled in parallel with each other, with the third TS, and with the fourth TS via the second switch terminal of each of the second set of intermediate TSs; and a second set of intermediate voltage terminals, each intermediate voltage terminal of the second set of intermediate voltage terminals coupled to the first switch terminal of a corresponding intermediate TS of the second set of intermediate TSs.
In Example 16, the subject matter of Examples 13-15 includes subject matter where the first voltage signal is an input voltage signal, wherein the second voltage signal and the third voltage signal are output voltage signals, and wherein the fourth voltage signal is a system ground signal.
In Example 17, the subject matter of Examples 13-16 includes subject matter where the first voltage signal, the second voltage signal, the third voltage signal, and the fourth voltage signal are associated with a first voltage level, a second voltage level, a third voltage level, and a fourth voltage level respectively; and the first voltage level is higher than the second voltage level, the second voltage level is higher than the third voltage level, and the third voltage level is higher than the fourth voltage level.
In Example 18, the subject matter of Examples 13-17 includes a second VR comprising a first voltage terminal, a second voltage terminal, a third voltage terminal, and a fourth voltage terminal, wherein the third voltage terminal of the first VR is coupled in series with the first voltage terminal of the second VR, and wherein the fourth voltage terminal of the first VR is coupled in series with the second voltage terminal of the second VR.
In Example 19, the subject matter of Examples 13-18 includes a second VR comprising a first voltage terminal, a second voltage terminal, a third voltage terminal, and a fourth voltage terminal, wherein the third voltage terminal of the first VR is coupled in series with the first voltage terminal of the second VR, and wherein the fourth voltage terminal of the first VR is coupled in parallel with the fourth voltage terminal of the second VR.
Example 20 is a process of making a voltage regulator, comprising coupling a first transistor switch (TS) to a first voltage terminal and a top plate of a capacitor; coupling a second TS to a second voltage terminal and the top plate of the capacitor; coupling a third TS to a third voltage terminal and a bottom plate of the capacitor; and coupling a fourth TS to a fourth voltage terminal and to the bottom plate of the capacitor.
Example 21 is at least one machine-readable medium including instructions that, when executed by processing circuitry, cause the processing circuitry to perform operations to implement any of Examples 1-20.
Example 22 is an apparatus comprising means to implement any of Examples 1-20.
Example 23 is a system to implement any of Examples 1-20.
Example 24 is a method to implement any of Examples 1-20.

The above description is intended to be illustrative and not restrictive. For example, the above-described examples (or one or more aspects thereof) may be used in combination with others. Other embodiments may be used, such as by one of ordinary skill in the art upon reviewing the above description. The abstract is to allow the reader to ascertain the nature of the technical disclosure quickly. It is submitted with the understanding that it will not be used to interpret or limit the scope or meaning of the claims. Also, in the above Detailed Description, various features may be grouped to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined regarding the appended claims, along with the full scope of equivalents to which such claims are entitled.

What is claimed is:

1. An apparatus comprising:
a first transistor switch (TS) comprising a first switch terminal coupled to a first voltage terminal and a second switch terminal coupled to a top plate of a capacitor, the first voltage terminal to provide a first voltage signal;
a second TS comprising a first switch terminal coupled to a second voltage terminal and a second switch terminal coupled to the top plate and coupled in parallel with the second switch terminal of the first TS, the second voltage terminal to provide a second voltage signal;
a third TS comprising a first switch terminal coupled to a third voltage terminal and a second switch terminal coupled to a bottom plate of the capacitor, the third voltage terminal to provide a third voltage signal; and
a fourth TS comprising a first switch terminal coupled to a fourth voltage terminal and a second switch terminal coupled to the bottom plate and coupled in parallel with the second switch terminal of the third TS, the fourth voltage terminal to provide a fourth voltage signal.

2. The apparatus of claim 1, further comprising:
a first set of intermediate TSs, each intermediate TS of the first set of intermediate TSs comprising a first switch terminal and a second switch terminal, the first set of intermediate TSs coupled in parallel with each other, with the first TS, and with the second TS via the second switch terminal of each of the first set of intermediate TSs.

3. The apparatus of claim 2, further comprising:
a first set of intermediate voltage terminals, each intermediate voltage terminal of the first set of intermediate voltage terminals coupled to the first switch terminal of a corresponding intermediate TS of the first set of intermediate TSs.

4. The apparatus of claim 3, further comprising:
a second set of intermediate TSs, each intermediate TS of the second set of intermediate TSs comprising a first switch terminal and a second switch terminal, the second set of intermediate TSs coupled in parallel with each other, with the third TS, and with the fourth TS via the second switch terminal of each of the second set of intermediate TSs.

5. The apparatus of claim 4, further comprising:
a second set of intermediate voltage terminals, each intermediate voltage terminal of the second set of intermediate voltage terminals coupled to the first switch terminal of a corresponding intermediate TS of the second set of intermediate TSs.

6. The apparatus of claim 1, further comprising:
a fifth TS comprising a first switch terminal and a second switch terminal, the first switch terminal coupled to the first switch terminal of the first TS, and the second switch terminal coupled to the second switch terminal of the third TS.

7. The apparatus of claim 1, wherein the third voltage terminal is coupled in series with a first voltage terminal of at least another VR circuit, and wherein the fourth voltage terminal is coupled in series with a second voltage terminal of the at least another VR circuit.

8. The apparatus of claim 1, wherein the third voltage terminal is coupled in series with a first voltage terminal of at least another VR circuit, and wherein the fourth voltage terminal is coupled in parallel with a fourth voltage terminal of the at least another VR circuit.

9. The apparatus of claim 4, comprising:
a system-on-chip (SoC), the SoC comprising an integrated circuit (IC), the IC comprising at least two of the first TS, the second TS, the third TS, the fourth TS, the first set of intermediate TSs, and the second set of intermediate TSs.

10. The apparatus of claim 9, wherein the SoC further comprises at least one connector, and wherein the at least one connector conforms with at least one of Universal Serial Bus (USB), High-Definition Multimedia Interface (HDMI), Thunderbolt, Peripheral Component Interconnect Express (PCIe), and Ethernet specifications.

11. An apparatus comprising:
a first voltage regulator (VR) comprising:
a capacitor comprising a top plate and a bottom plate;
a first plurality of transistor switches (TSs), the first plurality of TSs comprising a corresponding plurality of first switch terminals and a corresponding plurality of second switch terminals, the plurality of second switch terminals of the first plurality of TSs coupled in parallel with each other and to the top plate; and
a second plurality of TSs, the second plurality of TSs comprising a corresponding plurality of first switch terminals and a corresponding plurality of second switch terminals, the plurality of second switch terminals of the second plurality of TSs coupled in parallel with each other and to the bottom plate.

12. The apparatus of claim 11, wherein the first plurality of TSs comprises:
a first TS comprising a first switch terminal coupled to a first voltage terminal and a second switch terminal coupled to the top plate, the first voltage terminal to provide a first voltage signal; and
a second TS comprising a first switch terminal coupled to a second voltage terminal and a second switch terminal coupled to the top plate, the second voltage terminal to provide a second voltage signal.

13. The apparatus of claim 12, wherein the second plurality of TSs comprises:
a third TS comprising a first switch terminal coupled to a third voltage terminal and a second switch terminal coupled to the bottom plate, the third voltage terminal to provide a third voltage signal; and
a fourth TS comprising a first switch terminal coupled to a fourth voltage terminal and a second switch terminal coupled to the bottom plate, the fourth voltage terminal to provide a fourth voltage signal.

14. The apparatus of claim 13, wherein the first plurality of TSs comprises:
a first set of intermediate TSs, each intermediate TS of the first set of intermediate TSs comprising a first switch terminal and a second switch terminal, the first set of intermediate TSs coupled in parallel with each other, with the first TS, and with the second TS via the second switch terminal of each of the first set of intermediate TSs; and
a first set of intermediate voltage terminals, each intermediate voltage terminal of the first set of intermediate voltage terminals coupled to the first switch terminal of a corresponding intermediate TS of the first set of intermediate TSs.

15. The apparatus of claim 14, wherein the second plurality of TSs comprises:
a second set of intermediate TSs, each intermediate TS of the second set of intermediate TSs comprising a first switch terminal and a second switch terminal, the second set of intermediate TSs coupled in parallel with each other, with the third TS, and with the fourth TS via the second switch terminal of each of the second set of intermediate TSs; and
a second set of intermediate voltage terminals, each intermediate voltage terminal of the second set of intermediate voltage terminals coupled to the first switch terminal of a corresponding intermediate TS of the second set of intermediate TSs.

16. The apparatus of claim 13, wherein the first voltage signal is an input voltage signal, wherein the second voltage signal and the third voltage signal are output voltage signals, and wherein the fourth voltage signal is a system ground signal.

17. The apparatus of claim 13, wherein:
the first voltage signal, the second voltage signal, the third voltage signal, and the fourth voltage signal are associated with a first voltage level, a second voltage level, a third voltage level, and a fourth voltage level respectively; and
the first voltage level is higher than the second voltage level, the second voltage level is higher than the third voltage level, and the third voltage level is higher than the fourth voltage level.

18. The apparatus of claim 13, further comprising:
a second VR comprising a first voltage terminal, a second voltage terminal, a third voltage terminal, and a fourth voltage terminal, wherein the third voltage terminal of the first VR is coupled in series with the first voltage terminal of the second VR, and wherein the fourth voltage terminal of the first VR is coupled in series with the second voltage terminal of the second VR.

19. The apparatus of claim 13, further comprising:
a second VR comprising a first voltage terminal, a second voltage terminal, a third voltage terminal, and a fourth voltage terminal, wherein the third voltage terminal of the first VR is coupled in series with the first voltage terminal of the second VR, and wherein the fourth voltage terminal of the first VR is coupled in parallel with the fourth voltage terminal of the second VR.

20. A process of making a voltage regulator, comprising:
coupling a first transistor switch (TS) to a first voltage terminal and a top plate of a capacitor;
coupling a second TS to a second voltage terminal and the top plate of the capacitor;
coupling a third TS to a third voltage terminal and a bottom plate of the capacitor; and
coupling a fourth TS to a fourth voltage terminal and the bottom plate of the capacitor.
